(19) United States
(12) Patent Application Publication
(10) Pub. No.: US 2011/0199339 A1
(43) Pub. Date: Aug. 18, 2011

(54) Object Locating System with Cameras Attached to Frame

(76) Inventors: John J Briden, San Francisco, CA (US); Kwang Ho Kim, Santa Clara, CA (US); John P. McCarthy, Castro Valley, CA (US)

(21) Appl. No.: 13/123,715

(22) PCT Filed: Oct. 30, 2008
(86) PCT No.: PCT/US2008/081673

§ 371 Date: Apr. 11, 2011

(51) Int. Cl. G06F 3/042

(52) U.S. Cl. 345/175

(57) ABSTRACT

An imaging system includes a frame with a retroreflective bezel and cameras attached directly to the frame.

### BACKGROUND

A “touchscreen” is a display that can detect and locate an object, such as a finger, touching a display screen. Touchscreen capabilities can be enabled by a range of technologies including resistive, surface acoustic wave, capacitive, infrared, strain gage, diffused laser imaging, optical imaging, dispersive signal technology, and acoustic pulse recognition. A touchscreen allows user input without requiring a separate device such as a mouse or trackpad. Unlike those devices, a touchscreen enables a user to interact with what is displayed directly on the screen, where it is displayed, rather than indirectly.

To leverage the economies of scale associated with the manufacture of non-touchscreen LCD displays, some touchscreen displays are manufactured by adding a touchscreen add-on to a conventional LCD display. For example, a conventional LCD screen can be overlaid with an assembly including a glass plate having cameras mounted on its corners. Camera alignment is critical and care must be taken to prevent condensation from forming between the display screen and the glass overlay both during manufacture and during use. Strict tolerances and a cleanroom assembly line are required and account for much of the cost of a touchscreen display. Even with careful camera alignment during manufacture, movement of cameras when the glass is deformed under the pressure of a touch can impair functionality.

### BRIEF DESCRIPTION OF THE DRAWINGS

The features and advantages of the invention as well as additional features and advantages thereof will be more clearly understood hereinafter as a result of a detailed description of a preferred embodiment of the invention when taken in conjunction with the following drawings in which:

FIG. 1 is a schematic perspective view of a touchscreen display system in accordance with an embodiment of the invention.

FIG. 2 is a schematic perspective view of a touchscreen add-on used in the display system of FIG. 1 metal frame touchscreen assembly.

FIG. 3 is a detailed view of an upper right corner of the add-on of FIG. 2 showing a housing for a camera-emitter assembly.

FIG. 4 is a schematic sectional view of the right corner of the touchscreen add-on of FIGS. 2.

FIG. 5 is a schematic sectional view of the upper right corner of the touchscreen add-on of FIG. 2.

FIG. 6 is a schematic sectional view of the upper right corner of a touchscreen add-on for a second embodiment of the invention.

FIG. 7 is a schematic sectional view of the upper right corner of a touchscreen add-on for a third embodiment of the invention.

FIG. 8 is a schematic sectional view of the upper right corner of a touchscreen add-on for a fourth embodiment of the invention.

FIG. 9 is a flow chart of a method in accordance with an embodiment of the invention.

### DETAILED DESCRIPTION

The embodiments described herein provide for a metal frame with camera-emitter assemblies pre-attached. There is no glass panel overlaying the display screen; rather, the display screen itself can serve as a touch surface. The resulting touchscreen add-on is lighter and requires less material than a glass-based touchscreen add-on. More importantly, the area over the display screen is not covered, so there is no problem with condensation forming between the display screen and an overlying glass plate during or after manufacture. Furthermore, since the camera assemblies are attached to the metal frame, they are not displaced when touching deforms the display surface.

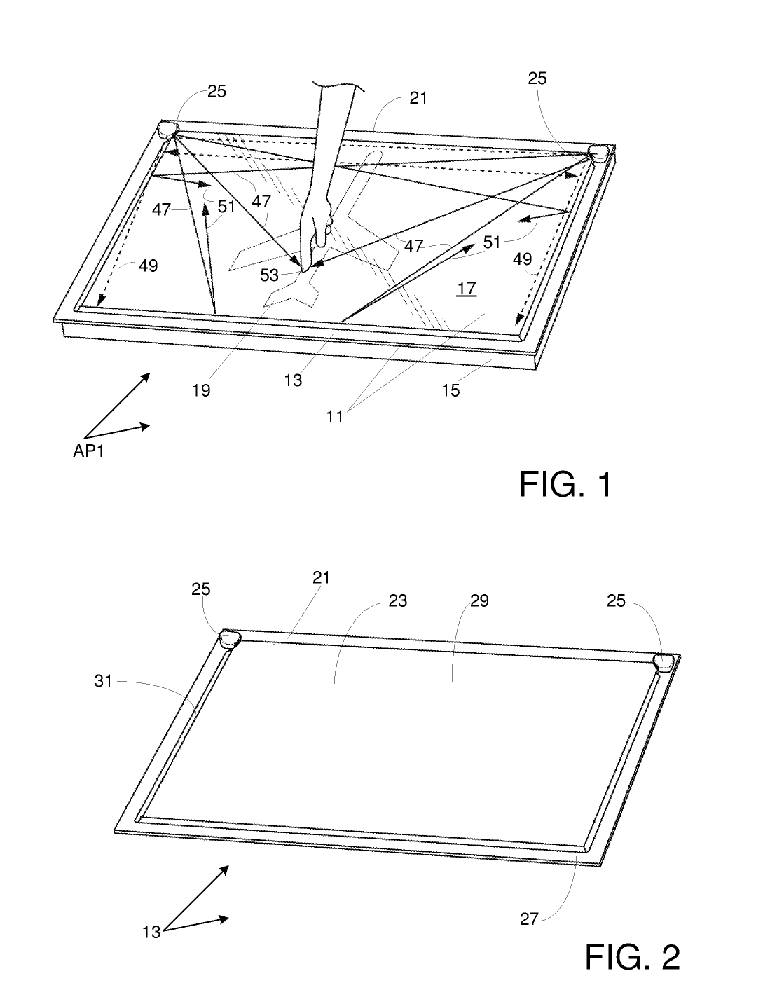

A display system API in accordance with an embodiment of the invention is shown in FIG. 1. Display system APT includes a display 11 and a touchscreen add-on 13. Display 11 includes a display housing 15 and a display screen 17 on which a user can view presentation images 19.

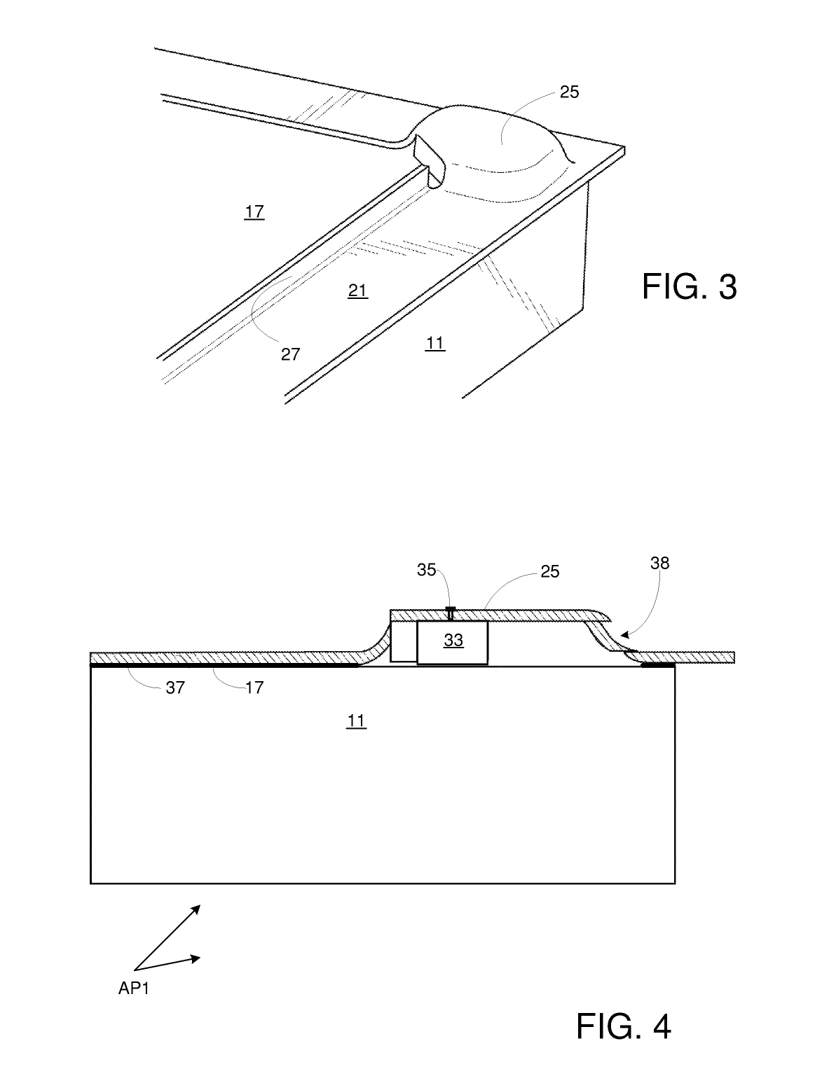

Touchscreen add-on 13, shown separately in FIG. 2, includes a rectangular frame 21 that defines a rectangular viewing aperture 23 through which a user can view display screen 17 and its presentation image 19 (FIG. 1). Touchscreen add-on 13 does not include a glass plate, so viewing aperture 23 is “empty”. The embodiments provide for other shapes of frames and apertures, but as most LED display screens are of a rectangular nature, viewing aperture 23 is also rectangular so as to be coextensive with screen 15. Frame 21 is formed from rigid sheet metal, e.g., aluminum. Frame 21 includes formed features including housings 25 and a bezel 27, which extends around three sides of the perimeter 29 of viewing aperture 23. Retroreflective material 31 has been applied to the inner (facing aperture 23) sides of bezel 27 to render it retroreflective. FIG. 3 shows one of housings 25 and part of bezel 27 in greater detail.

As shown in FIG. 4 for one housing, housings 25 enclose camera-emitter assemblies 33. Camera-emitter assemblies 33 are attached to housings 25 and thus frame 21 by screws 35. As indicated by FIG. 4, assemblies 33 are flush with display screen 17. However, camera-emitter assemblies 33 are not attached directly to display 11, except through their attachment to frame 21 when it is attached to display 11 by glue 37 or other adhesive. Thus, if display screen 17 is depressed by a touch, camera-emitter assemblies 33 do not move with it. Housings 25 include routing apertures 38 on their sides opposite viewing aperture 23 to allow wiring to exit housings 25 for power and data connectivity for camera-emitter assemblies 33.

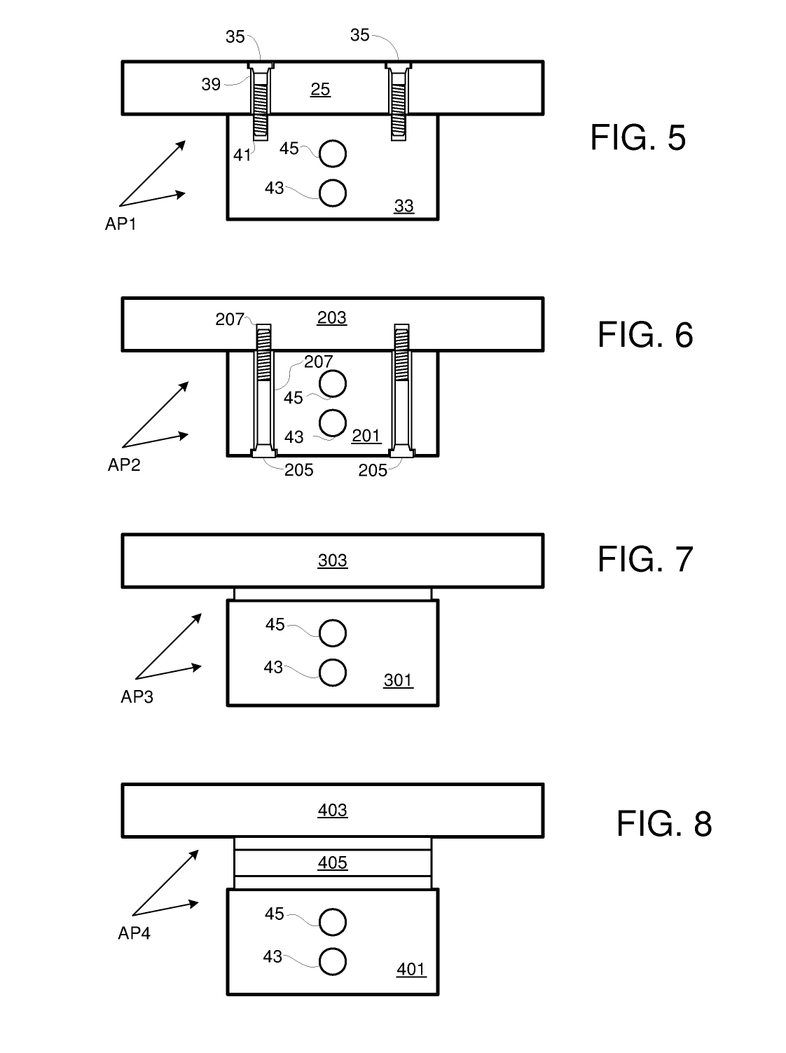

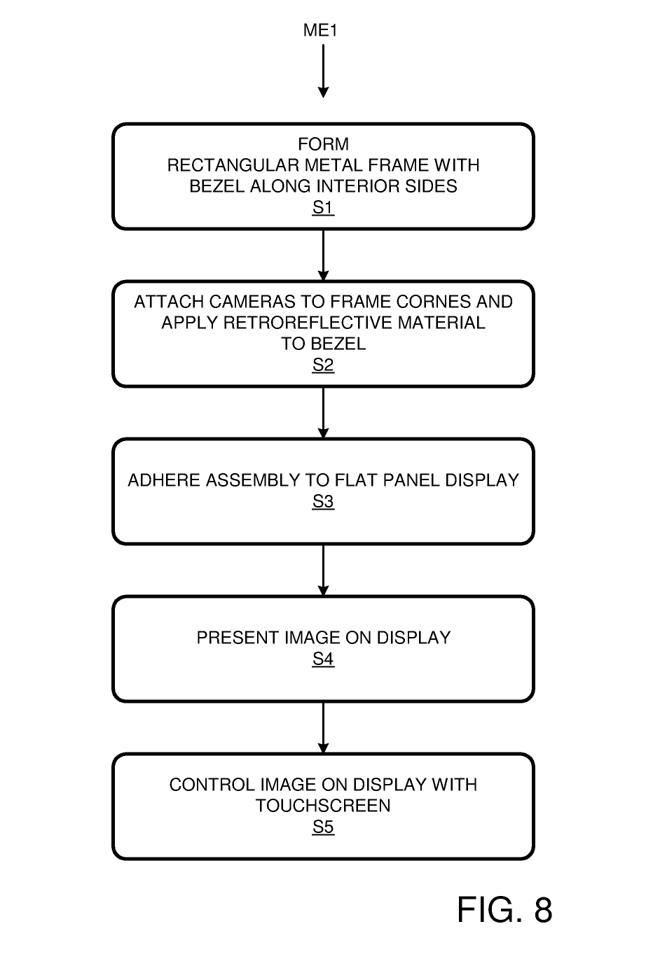

As indicated in FIG. 5, threaded screws 35 extend through unthreaded holes 39 of housings 25 and thus frame 21 and into threaded holes 41 of camera-emitter assemblies 33. Other embodiments provide for other means of attaching camera-emitter assemblies to housings. For example, FIG. 6 represents a touchscreen display system AP2 in which camera-emitter assemblies 201 are attached to a frame 203 using screws 205 which extend through unthreaded holes 207 of camera-emitter assemblies 201 and into threaded holes 211 of frame 203. In a touchscreen display system AP3, represented in FIG. 7, camera-emitter assemblies 301 are attached to frame 303 using glue 305. in an touchscreen display system AP4, represented in FIG. 8, the invention provides for camera-emitter assemblies 401 that are attached to a frame 403 using double-side tape 405.

The camera-emitter assemblies 33, 201, 301, and 401 of FIGS. 5-8 each include a camera 43 and an emitter 45. Each camera 43 can include a lens and an array detector. The array can be linear or two-dimensional. Each emitter can be an infrared light-emitting diode (LED). Each camera can include a visible and ultraviolet light filter to improve the signal-to-noise ratio.

In use, each emitter 45 directs IR light 47 from its housing 25 toward opposing sides of bezel 27, as shown FIG. 1. This implies that at least part of frame 21 is within respective fields-of-view 49 of cameras 43 (FIG. 4). Since bezel 27 is rendered retroreflective, IR light 47 arriving from a housing 25 is reflected to yield reflected IR light 51 that is directed back along a path toward the source housing 25, as indicated in FIG. 1. If a finger 53 or other object blocks emitted light 47 and/or reflected light 51, each camera 43 (FIG. 4) will detect the one-dimensional location of the finger from its point of view as a dark band in its location image. Image processing circuitry or software can combine location images from different cameras to determine a two-dimensional location of an object with respect to display screen 15. In an alternative embodiment, four cameras residing at all four corners of a rectangular frame are used to result the locations of multiple objects for use in multi-touch systems.

The technology described herein provides for a method ME1, flow charted in FIG. 8. At step S1, a frame is formed of rigid sheet metal. Camera-emitter assembly housings are formed in the sheet metal, e.g., at opposing top corners or all corners of the viewing aperture defined by the frame. A bezel is formed about the perimeter of the viewing aperture.

At step S2, camera-emitter assemblies are attached to the frame. Screws can extend through unthreaded holes in either the camera-emitter assemblies or in the frame and extend into threaded holes in the other component. Alternatively, camera-emitter assemblies can be attached to he housings and thus the frame using glue or double-sided tape. In addition, retroreflective material can be applied to the bezel rendering it retroreflective. The result of step S21 is a touchscreen add-on assembly.

At step S3, the touchscreen add-on assembly is attached to a display, e.g., using glue 37 (FIG. 4) to attach add-on 13 to LCD display 11. Of course, display technology is rapidly evolving and the present invention can be applied to both existing and future displays. In the illustrated embodiment, the add-on assembly can be glued to the display. The result of step S3 is a touch-screen display.

At step S4, a video or still presentation image is presented on a display screen of a display. The presentation image can be provided by a computer, for example. The computer can be a separate entity. Alternatively, a display system can be an all-in-one computer in which data and image processing is performed using computer components built into the back of a display housing.

At step S5, a user controls the presentation image by imposing one or more objects, e.g., a finger in contact with or sufficiently proximate to a display screen that h blocks emitted and/or reflected light from being detected by a camera. The resulting images (from plural cameras) can b analyzed to determine object position and gestures. This interpretation can be used, e.g., by an operating system or an application program, to control the presentation image.

Herein, an “imaging system” is a system that generates, captures, and/or displays images. An “object locating system” is a system, such as touchscreen add-on 13, that locates an object within a given area or volume, such as the volume near a display screen and within a frame. A “frame” is used for visually demarking a viewing area defined by an aperture defined and surrounded by the frame. A typical frame is generally planar and rectangular and has a rectangular viewing aperture. However, frames and their apertures can have a wide variety of two-dimensional shapes, including circles, ovals, ellipses, that do not have corners, and any polygonal shape.

A “bezel” is typically a low-aspect-ratio wall bounding an aperture or recess. In the present case, a bezel extends generally orthogonal to the bulk of the frame, although bezels can extend at other angles as well. “Retroreflective” is a property of a material or surface that reflects light back along the direction from which it came. A mirror only has this property for light that arrives orthogonal to the mirror. A retroreflective material or surface has this property for a range of non-orthogonal angles of incidence.

A “perimeter” is a closed outer boundary. In the present case, the perimeter of the aperture defined by the frame is of interest as the location of the retroreflective bezel. A “camera” is a device that captures images of one, two, or more spatial dimensions; the cameras discussed herein are “video cameras” in that they can produce a series of images that represent motion over a temporal dimension. A typical camera includes an array sensor, with a linear or two-dimensional array of detectors, e.g., a CCD or CMOS sensor. A camera will also typically include a lens or lens assembly for focusing incoming light on the sensor.

An “image” is a pattern of luminance and in some cases color. In the present case, the light source is essentially monochromatic, so an image is a one or two-dimensional spatial distribution of luminance. Still images can be used to detect the location of an object, while moving images can be used to detect: gestures. “Light” herein encompasses visible, ultraviolet, and infrared light.

An “emitter” is a device that emits light. For example, an infrared LED can serve as an emitter. In the illustrated embodiments, the emitters emit infrared light toward the retroreflective bezel. A camera-emitter assembly includes both a camera and an emitter. In the illustrated embodiments, the emitter directs light toward a retroreflective bezel, which reflects the incident light back toward the nearly co-located camera. Objects located in the frame aperture can block emitted light from reaching the bezel and reflected light from returning to the camera. This results in an image in the form of a spatial (still image) or spatial and temporal (video image) light distribution that can be analyzed to locate the object or to identify a gesture.

“Attached” herein means fixed to directly. Object A is attached to object B if A is fixed to B and 1) A is in contact with B, or 2) A and B are both in contact with adhesive material (glue or double-0side tape) used. to fix A to B. A is “rigidly coupled” to B is A's position with respect to B is fixed. A can be rigidly coupled to B without being attached to B, e.g., where they are both attached to an intervening structural member. For example, once the frame of the invention is attached to a display, the camera assemblies are rigidly coupled to the display because both are attached and fixed to the frame. However, the camera-emitter assemblies are not attached to the display.

A “display screen” is a portion of a display on which an image is presented. A display is a device including a display screen. A display may have additional functions, such as sound output from integrated speakers or switches to turn power on and off. “Coextensive” means that their orthogonal projections throughout space are substantially coincident. To put a value on “substantially” in this context, At least 90% of each projection should intersect the other projection. The display and aperture are “aligned” if their orthogonal projections overlap.

“Touchscreen” refers to displays and add-ons therefor that detect and locate an object that is touching a display screen or a window overlaying a display screen. A touchscreen need not rely on touch to trigger detections and may not require actual touching; for this reason, the invention can be considered as directed toward an “object locating system”. A touchscreen or object locating system in accordance with the present invention provides for detecting an object adjacent to but not touching a display screen can be detected.

The foregoing description, for purposes of explanation, has been described with reference to specific embodiments. However, the illustrative discussions are not intended to be exhaustive or to limit the invention to the precise forms disclosed. Many modifications and variations are possible in view of the disclosed teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An object locating system comprising:
a frame defining an aperture with a perimeter, said frame having a retroreflective bezel about at least most of said perimeter; and
plural cameras attached directly to said frame.

2. An object locating system as recited in claim 1 further comprising camera-emitter assemblies, each of said camera-emitter assemblies including at least one of said cameras.

3. An object locating system as recited in claim 2 wherein said frame has corners and said camera-emitter assemblies are located in at least two of said corners.

4. object locating system as recited in claim 2 further comprising a display having a display screen, said frame being attached to said display so that said aperture is substantially coextensive with said display screen.

5. An object locating system as recited in claim 4 wherein said camera-emitter assemblies are rigidly connected to said display through said frame and are not directly attached to said display.

6. An object locating system as recited in claim 5 wherein said camera-emitter-assemblies sit flush with said display screen.

7. An object locating system as recited in claim 3 wherein said camera-emitter-assemblies are attached to said frame with screws.

8. An object locating system as recited in claim 7 wherein said cameras have unthreaded holes and said frame has threaded holes, said screws passing through said unthreaded holes and into said threaded holes.

9. An object locating system as recited in claim 7 wherein said camera-emitter assemblies have threaded holes and said frame has unthreaded holes, said screws passing through said unthreaded holes and into said threaded holes.

10. An object locating system as recited in claim 7 wherein said camera-emitter assemblies are attached to said frame with glue that contacts said cameras and said frame.

11. A method comprising:
forming a frame defining an aperture with a perimeter and a bezel about at least most of said perimeter; and
attaching camera-emitter assemblies to said frame and applying retroreflective material to said bezel.

12. A method as recited in claim 11 further comprising, after said assemblies are attached to said frame, attaching said frame to a display having a display screen so that said aperture is alighted with said display screen.

13. Method as recited in claim 12 further comprising, after attaching said frame to said display, presenting an image on said display.

14. A method as recited in claim 13 further comprising controlling said image by selectively blocking light emitted by said camera-emitter assemblies toward said bezel from being detected by said camera-emitter assemblies.

15. A method as recited in claim 14 wherein said light is infrared light.
